(19) United States
(12) Patent Application Publication
(10) Pub. No.: US 2013/0067412 A1
(43) Pub. Date: Mar. 14, 2013

(54) GROUPING SELECTABLE TILES

(71) Applicants: Chantal M. Leonard, Seattle, WA (US); Holger Kuehnle, Seattle, WA (US); John C. Whytock, Portland, OR (US); Rebecca Deutsch, Seattle, WA (US); Patrice L. Miner, Kirkland, WA (US)

(72) Inventors: Chantal M. Leonard, Seattle, WA (US); Holger Kuehnle, Seattle, WA (US); John C. Whytock, Portland, OR (US); Rebecca Deutsch, Seattle, WA (US); Patrice L. Miner, Kirkland, WA (US)

(73) Assignee: Microsoft Corporation, Redmond, WA (US)

(21) Appl. No.: 13/229,155

(22) Filed: Sep. 9, 2011

(51) Int. Cl. G06F 3/048

(52) U.S. Cl. 715/835

(57) ABSTRACT

This document describes techniques for grouping selectable tiles. These techniques enable a user to create and manage flexibly-sized groups rather than constrain the user to groups of a particular size. Further, these techniques enable users to view selectable tiles in multiple groups simultaneously, which can help user quickly and easily find and select a desired tile.

### BACKGROUND

Many conventional selection interfaces permit users to select files, applications, and the like by selecting an associated icon within the interface. These interfaces often show these icons in a flat list, a file-based hierarchy, or grouped by page. Each of these types of interfaces, however, can be tedious or time-consumer for users to manage or use.

If a user wishes to select a particular icon in a flat list, for example, the user often must scroll through many icons without the benefit of organization. Without organization, users typically study each icon in the list in an attempt to find the particular icon. Users do so because, without organization, there is little way in which to understand the likelihood that any arbitrary icon in the list is the particular icon desired by the user.

If a user wishes to select a particular icon in a file-based hierarchy, for example, the user often must search through multiple levels of the hierarchy. The user starts at a higher level of the hierarchy, searching through the higher level to find a most-likely lower level of the hierarchy, searches through that lower level, and so forth until the user sees a group showing the icons from which to search and select. Even if the group includes the particular icon, getting to that group can be tedious and time consuming. If the group doesn't include the particular icon, the user searches through the hierarchy again, and so forth, until the user finds the group having the particular icon.

If a user wishes to select a particular icon in an interface where icons are grouped by page, for example, the user may struggle with the constraints dictated by those pages. Organization is useful, but mental groupings of icons may be included in one, two, three, or more pages. When a mental group covers multiple pages, the multipage group can suffer from some of the tedium present in flat lists. Users are often aware of this deficiency and, to address it, are forced to constrain or modify their natural mental groupings to fit the page sizes. Even with this problem of multipage groups partly addressed, users often struggle with the groups they have built because, as noted, the groupings are not natural mental groups for the user.

### SUMMARY

This document describes techniques for grouping selectable tiles. These techniques enable a user to create and manage flexibly-sized groups rather than constrain the user to groups of a particular size. Further, these techniques enable users to view selectable tiles in multiple groups simultaneously, which can help user quickly and easily find and select a desired tile.

This summary is provided to introduce simplified concepts for grouping selectable tiles that are further described below in the Detailed Description and/or shown in the Figures. This summary is not intended to identify essential features of the claimed subject matter, nor is it intended for use in determining the scope of the claimed subject matter. The term “techniques” as used herein can include devices, systems, apparatuses, operations, and/or methods as permitted by the context in which the term is used.

### BRIEF DESCRIPTION OF THE DRAWINGS

Embodiments for grouping selectable tiles are described with reference to the following drawings. The same numbers are used throughout the drawings to reference like features and components:

FIG. 1 illustrates an example system in which techniques for grouping selectable tiles can be implemented.

FIG. 2 illustrates an example method for grouping selectable tiles, including ways in which to present and enable selection of the tiles.

FIG. 3 illustrates an example selection interface having three groups of selectable tiles.

FIG. 4 illustrates the interface of FIG. 3 with some tiles shown at larger size and greater resolution.

FIG. 5 illustrates an example method for grouping selectable tiles, including ways in which to manage these groups.

FIG. 6 illustrates the interface of FIG. 3 with a marked region having three small tiles selected to add to a new group.

FIG. 7 illustrates a new group, along with groups shown in FIG. 6.

FIG. 8 illustrates multiple tiles in four groups, three of the groups fully shown and one of the groups partially shown, and a gesture moving a selected tile.

FIG. 9 illustrates a new group along with three groups previously shown in FIG. 8.

FIG. 10 illustrates an example method for grouping selectable tiles, including ways in which to move and arrange groups.

FIG. 11 illustrates a gesture selection to drag a group from an original location to a new location at blank space between groups.

FIG. 12 illustrates the interface of FIG. 11 with the selected group at the new location and the groups reordered.

FIG. 13 illustrates an example device in which techniques for grouping selectable tiles can be implemented.

### DETAILED DESCRIPTION

Overview

This document describes techniques for grouping selectable tiles. These techniques enable users to create groups, manage those groups, and select tiles from within groups quickly and easily. For application-launching interfaces, for example, the techniques permit a user to create and organize groups of selectable tiles according to that user's natural mental grouping for applications. A user may build a group of work-related tiles for work-related applications, whether that group fills half a page or many, a group of play-related tiles for fun applications, again based on the user's selected size, and so forth.

While techniques for grouping selectable tiles can be implemented in any number of different devices, systems, environments, and/or configurations, example embodiments for grouping selectable tiles are described in the context of the following example devices, systems, and methods.

Example System

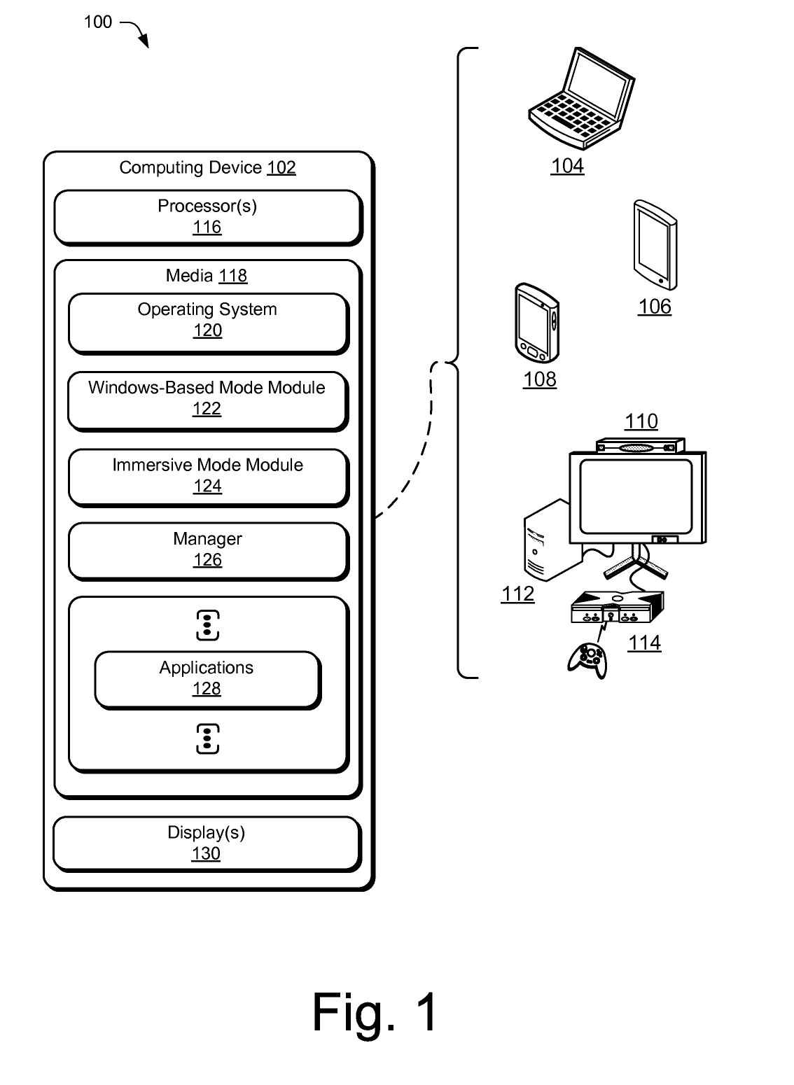

FIG. 1 illustrates an example system 100 in which techniques for grouping selectable tiles can be embodied. System 100 includes a computing device 102, which is illustrated with six examples: a laptop computer 104, a tablet computer 106, a smart phone 108, a set-top box 110, a desktop computer 112, and a gaming device 114, though other computing devices and systems, such as servers and netbooks, may also be used.

Computing device 102 includes computer processor(s) 116 and computer-readable storage media 118 (media 118). Media 118 includes an operating system 120, windows-based mode module 122, immersive mode module 124, manager 126, and applications 128. Computing device 102 also includes or has access to one or more displays 130, four examples of which are illustrated in FIG. 1.

Windows-based mode module 122 is capable of presenting applications 128 through windows having frames. These frames may provide controls through which to interact with an application and/or controls enabling a user to move and size the window.

Immersive mode module 124 provides a mode by which a user may view and interact with applications 128. In some embodiments, this mode presents content of, and enables interaction with, applications with little or no window frame and/or without a need for a user to manually size or position content. This mode can be, but is not required to be, hosted and/or surfaced without use of a typical desktop (e.g., windows-based) mode. Thus, in some cases immersive mode module 124 presents an immersive mode that is not a window (even one without a substantial frame) and precludes usage of desktop-like displays (e.g., a taskbar). Further still, in some embodiments this immersive mode is similar to an operating system in that it is not closeable or capable of being un-installed.

Manager 126 provides an application-selection interface that permits selection to launch, present, or revisit applications 128, whether of windows-based or immersive modes, and itself can be presented in a windows-based or immersive mode. Manager 126 also enables users to group tiles within the application-selection interface. Note that while system 100 and manager 126 are described in the context of application-selection interfaces, manager 126 may operate to group tiles, icons, or labels in other contexts, such as file systems, image retrieval systems, document retrieval systems, and the like.

Operating system 120, mode modules 122 and 124, and manager 126 can be separate from each other or combined or integrated in some form. Thus, in some cases operating system 120 includes mode modules 122 and 124 and manager 126.

Example Methods

This document now describes example methods for grouping selectable tiles. These methods are shown as sets of blocks that specify operations performed, but are not necessarily limited to the order shown. Portions of the following discussion reference system 100 of FIG. 1, reference to which is made for example only.

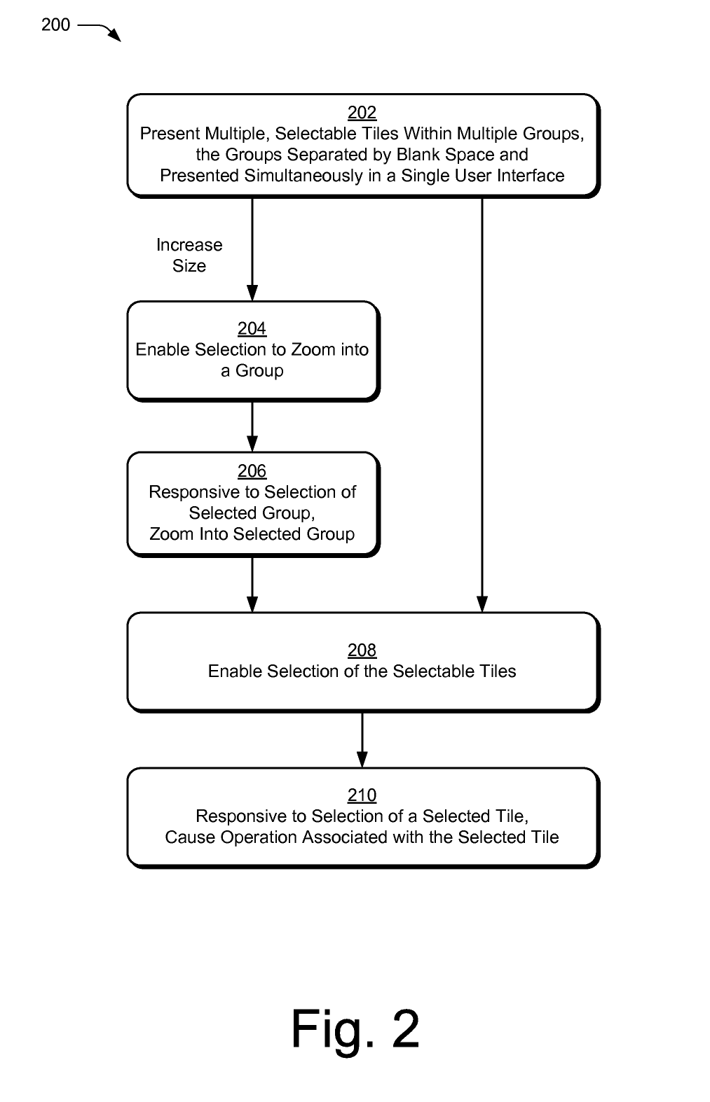

FIG. 2 depicts a method 200 for grouping selectable tiles, including ways in which to present and enable selection of the tiles. Block 202 presents multiple, selectable tiles within multiple groups, the groups separated by a visual element and presented simultaneously in a single user interface. This visual element can be large or small and include a color change, a marker, a border, a line, a space, or other indictor differentiating groups. In various examples set forth below, the visual element differentiates groups of selectable tiles through blank space, the blank space being larger than space between tiles within the groups.

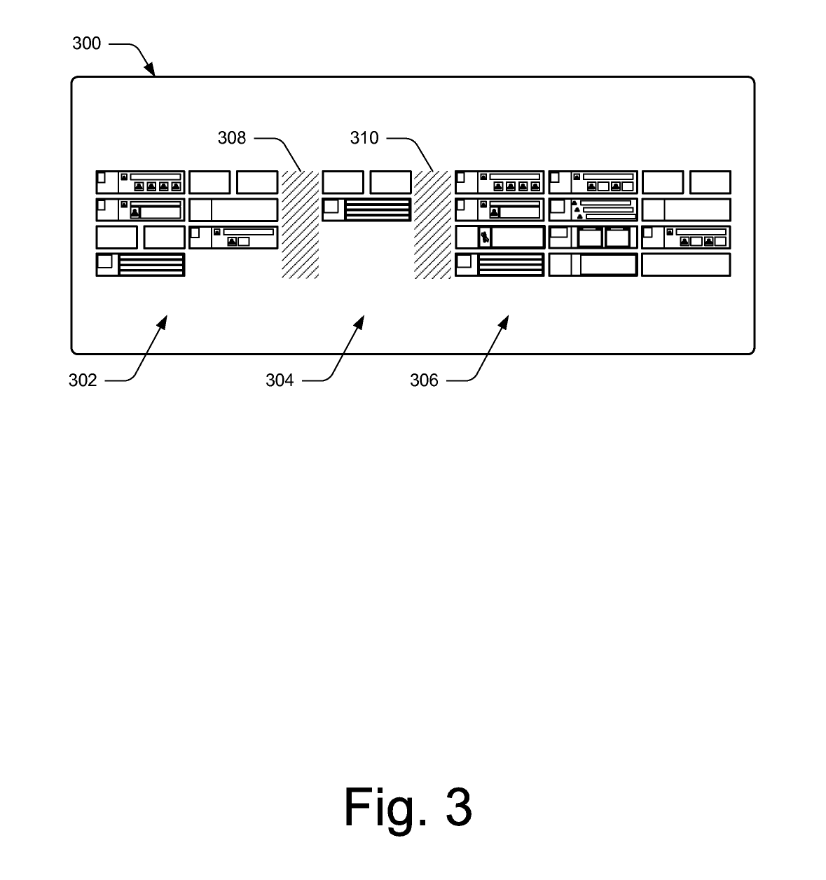

By way of example, consider FIG. 3, which illustrates selection interface 300 having three groups of selectable tiles, 302, 304, and 306. These three groups 302, 304, and 306 are separated by blank space 308 and 310, shown with hash lines for ease in description only. While these groups can, alternatively, be separated or identified by window chrome, boxes, or titles, blank space is effective to aid users in differentiating between groups and providing an organization apparent to users without distracting users or occupying substantial screen real estate.

As noted, each of groups 302, 304, and 306 do not include identifiers, such as group names. Instead, each of the groups can be identified as a group by blank space and differentiated from each other based on the tiles in the groups. In effect, a user may differentiate groups based on the contents of the group rather than metadata or some abstraction of the contents. A user may recognize his or her photography applications, for example, based on it being a small group or the group that has two small tiles on top (group 304). Or a user may recognize her work applications or favorite early-morning content providers (e.g., websites with news content) based on it having, on the upper left corner, two similar boxes-within-boxes, as shown in group 306. These are but two example ways in which users can, without an title or identifier, recognize groups, many others are possible as well (e.g., colors, sizes, where in the order a particular group resides, etc.).

Method 200 enables selection of selectable tiles at various sizes in a selection interface. The selection interface may, by default or user selection, show tiles at smaller or larger sizes. In the ongoing embodiment, selection interface 300 shows tiles at smaller sizes, from which method 200 permits immediate selection of the tiles or enables selection to increase the size and resolution responsive to a user selection. This alternative is shown in method 200 along an “Increase Size” path from block 202 to block 204.

Block 204 enables selection to zoom into a selected group prior to receiving selection of a selectable tile. In response to receiving selection of a selectable group, block 206 zooms into the selected group to show the tiles at a larger size and greater resolution.

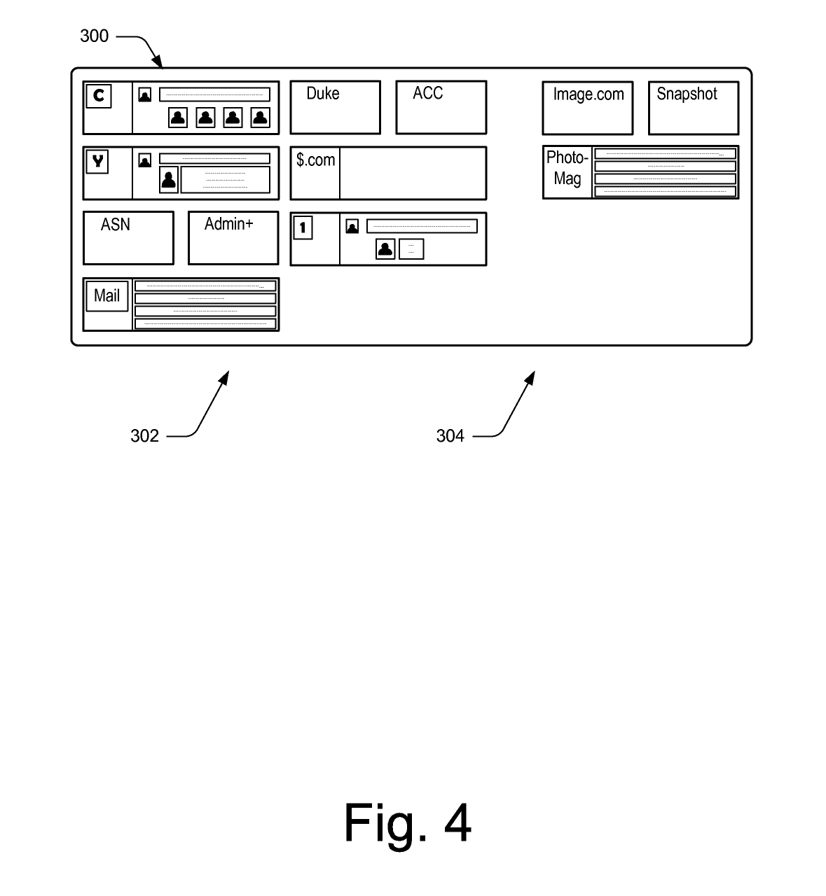

By way of example, assume that a user selects, such as by a tap gesture through selection interface 300, to see tiles of group 302 at a larger size and greater resolution. In response, manager 126 zooms into group 302, which is illustrated in FIG. 4. Note that in this case, zooming into group 302 presents the selectable tiles of group 302 but does not fill the viewable region on which the selectable tiles of the selected group are presented. In such a case, manager 126 may simultaneously present, also at the increased size, tiles of another, unselected group (group 304).

Whether method 200 performs blocks 204 and 206 or proceeds directly to block 208, block 208 enables selection of the selectable tiles, including with as little as one selection. This selection can be through any of various inputs, such as hotkeys, a mouse or gesture tap, a gesture drag-and-drop, and the like. Note that these tiles are selectable when one or multiple groups are presented. As this example illustrates, the techniques permit users to see multiple, selectable tiles from multiple groups and select these tiles without having to find the groups through a hierarchy or find the tiles without the benefit of organization.

Block 210, responsive to selection of a selected tile, causes an operation to be performed, such as performing an operation or launching or presenting an application associated with the selected tile.

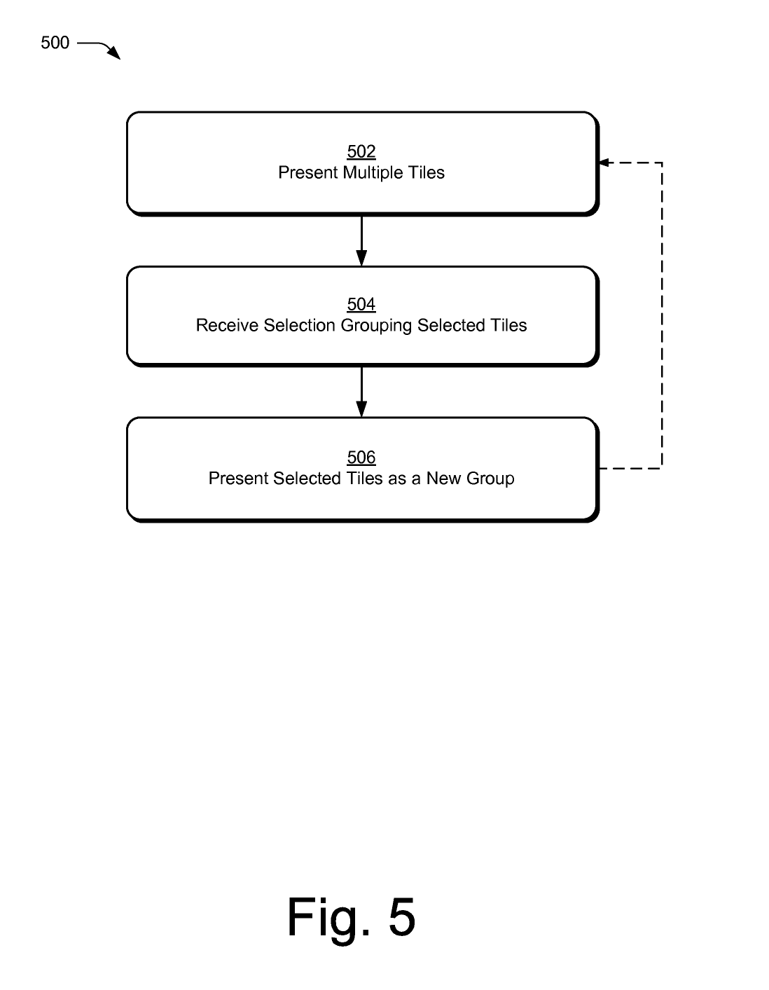

FIG. 5 depicts a method 500 for grouping selectable tiles, including ways in which to manage these groups. Method 500 may operate separate from, or in conjunction with, method 200 in whole or in part.

Block 502 presents multiple tiles. These tiles can be presented grouped or otherwise, and in an interface through which the tiles can be selected or a separate interface from which groups of tiles can be selected for later presentation in a selection interface.

By way of example, consider again FIG. 3, which illustrates selection interface 300 presenting three groups of selectable tiles, groups 302, 304, and 306. Here assume that manager 126 presents these groups of tiles and enables selection to manage tiles and groups, as will be described below.

Block 504 receives a selection grouping a first group of selected tiles. This selection can be received in various manners, such as with one or more multiple gestures dragging tiles to a new group location or a holding area for later creation of the group.

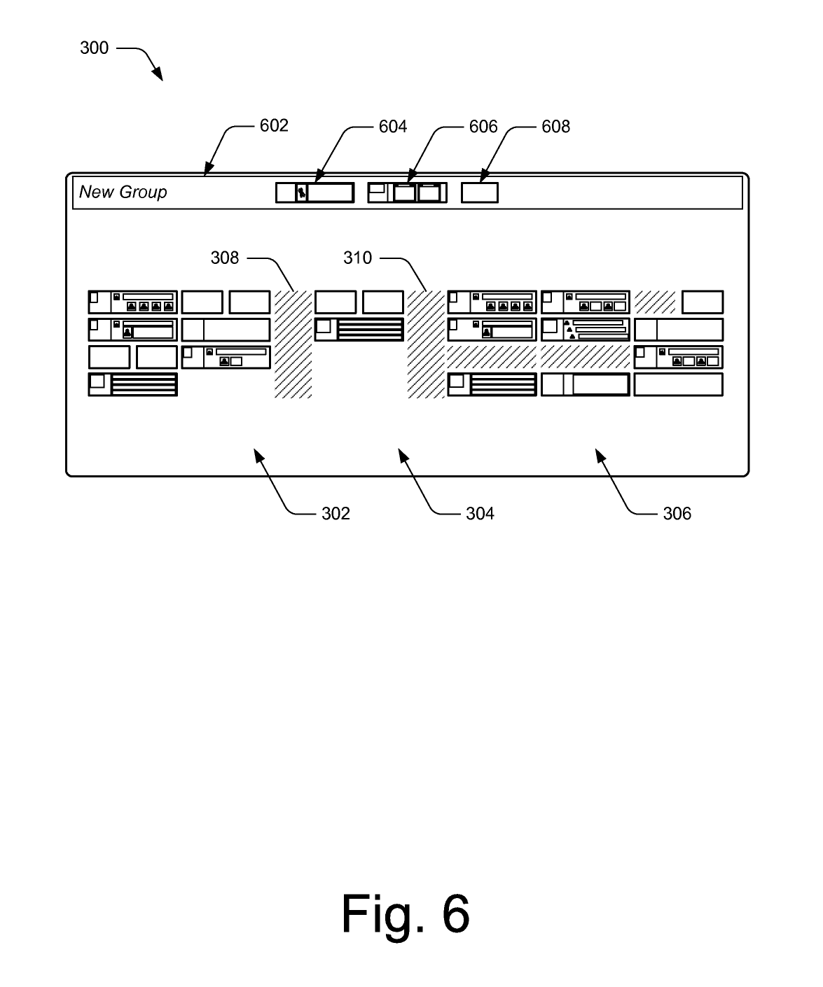

Assume, by way of a first example, that a user selects three tiles from group 306 by moving each of the three tiles from their original locations to a marked region of selection interface 300. This is illustrated in FIG. 6, which shows marked region 602 (labeled “New Group”) and three small tiles 604, 606, and 608 within marked region 602. After selecting the desired tiles, manager 126 enables selection of a location for the new group of tiles. Here assume that the user moves one of the tiles to a visual element in selection interface 300, such as blank space 310.

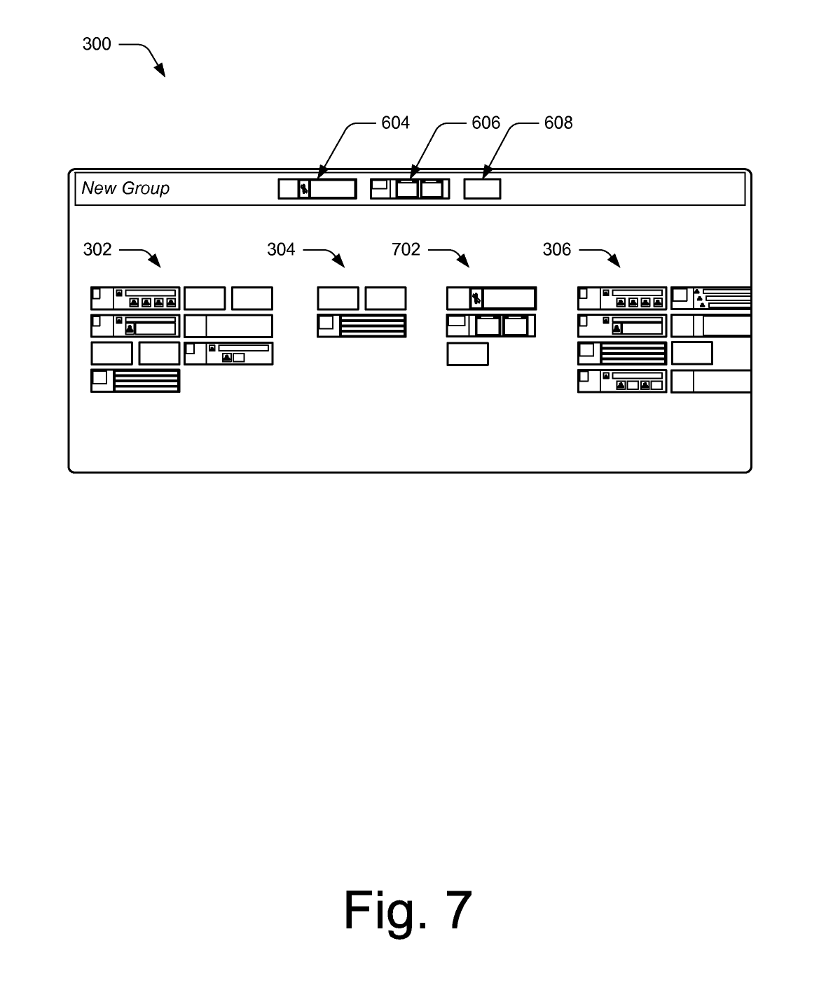

Block 506, responsive to receiving the selection of the first group, presents the selected tiles as a new group. This is illustrated in FIG. 7, which shows new group 702 along with groups 302 and 304, and a portion of group 306. Note also that manager 126 may automatically reflow tiles of group 306 to fill in the gaps created by removal of the tiles from group 306. This is shown, in part, in FIG. 7 at group 306. Manager 126 reflow tiles based on an order of superiority previously set for a group, such top-to-bottom by columns starting at a left-most column, in which case inferior tiles are filled in to the gaps by a reverse of the order for the group.

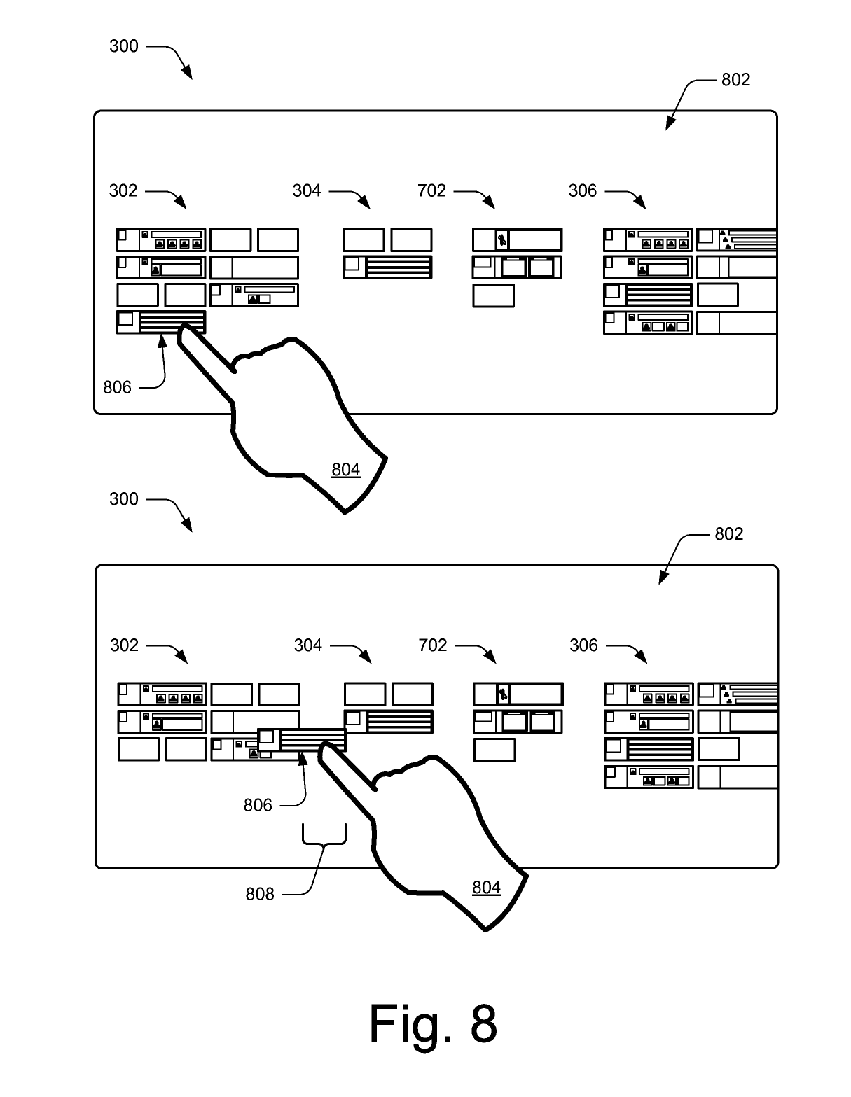

Blocks of method 500 can be repeated to build and manage groups, as shown with a dashed line in FIG. 5. Consider a second example repeating blocks 502, 504, and 506. Manager 126, at block 502, presents multiple tiles 802 as shown in FIG. 8, which includes prior groups 302, 304, 702, and portions of 306. In this second example, manager 126 enables selection to build a group through a single selection to move a tile. This is shown with a selection with gesture 804 dragging a tile 806 from group 302 to blank space 808 between groups at which point the gesture drops tile 806 in blank space 808. The start of gesture 804 and the end of gesture 804 are shown in FIG. 8.

As part of this second example, or for other types of selections, manager 126 may provide feedback as to a result of moving the tiles to various locations, such as blank space 808. This feedback may indicate the result, such as adding the selected tiles to an existing group or creating a new group. Thus, on passing tiles over (or hovering over) blank space 808, manager 126 may move apart the other groups 302 and 304, tilt the other groups 302 and 304, or provide an indicator, such as a blinking line or pop-up window with text “Create new group?”.

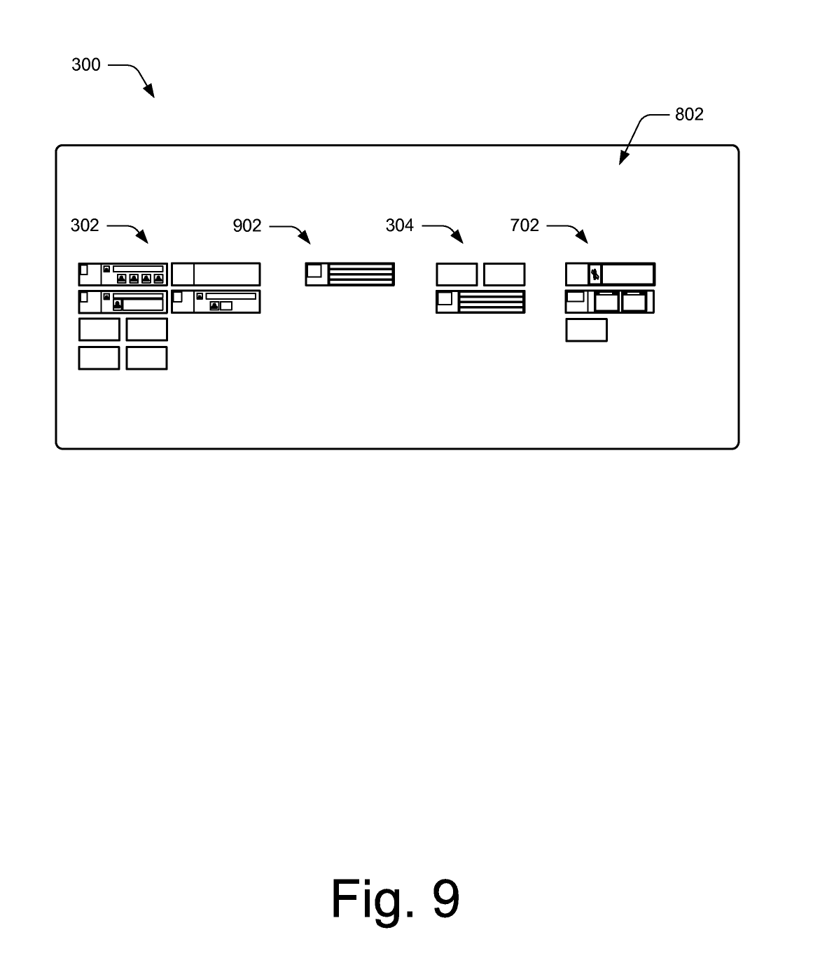

Manager 126, at block 506, presents, in the same, single user interface (interface 300), this group (which includes only tile 806 at this point), shown in FIG. 9. Manager 126 presents these groups 302, 902, 304, and 702 simultaneously and separated by blank space without additional identifiers. Note that manager 126 automatically reflows tiles of group 302 responsive to tile 806 being removed.

Following block 506, method 500 may proceed to enable selection of tiles and, responsive to selection, perform an operation associated with the selected tile, such as according to blocks 208 and 210 of method 200.

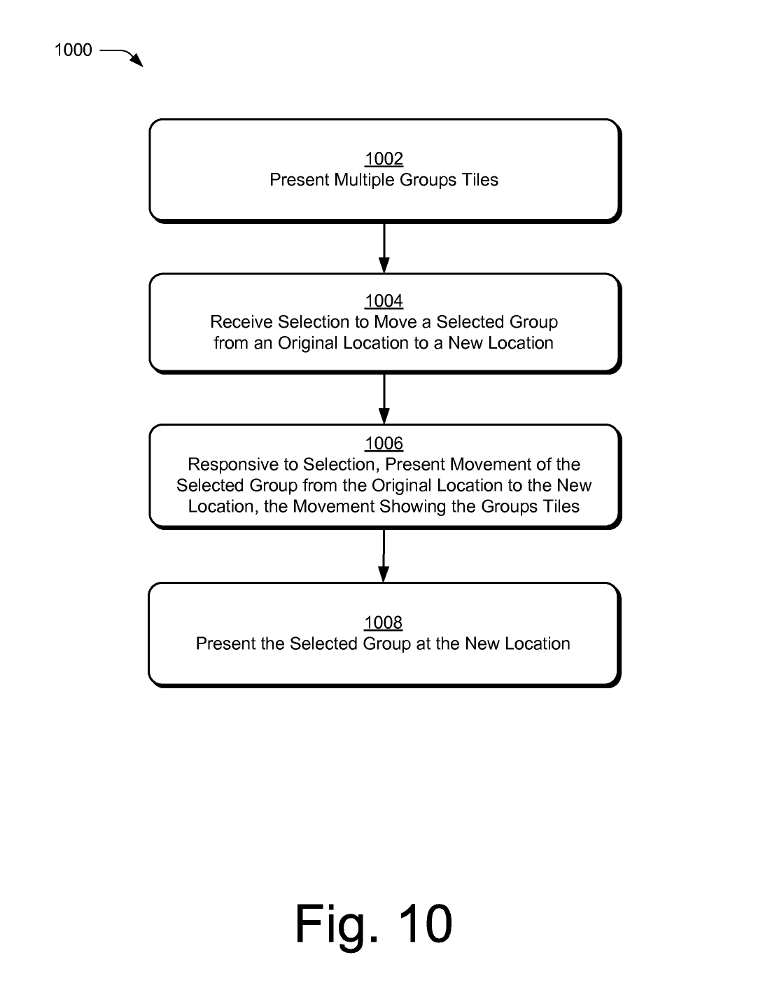

FIG. 10 depicts a method 1000 for grouping selectable tiles, including ways in which to move and arrange groups. Method 1000 may operate separate from, or in conjunction with, method 200 and/or method 500 in whole or in part.

Block 1002 presents multiple groups of tiles within a single user interface, such as those groups presented and described above. By way of example, consider again FIG. 9, which illustrates selection interface 300 having four groups of tiles, 302, 902, 304, and 702.

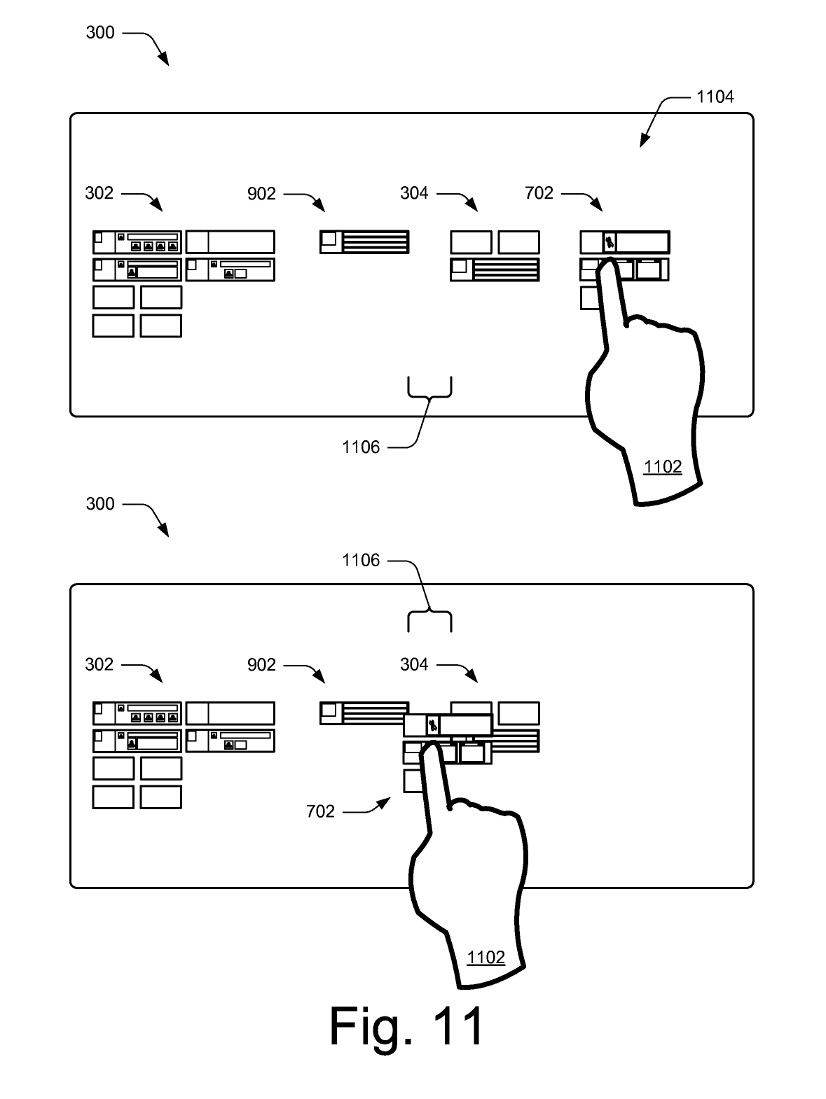

Block 1004 receives selection to move a selected group of the groups from an original location to a new location in the single user interface. The original location can be displayed at a same time as the new location or otherwise. The new location can be between, in front of, or adjacent to another group. Continuing the ongoing example, consider FIG. 11, in which a gesture 1102 drags group 702 from an original location 1104 to a new location at blank space 1106 between groups 902 and 304.

Block 1006, responsive to selection, presents movement of the selected group from the original location to the new location, the movement showing tiles within the selected group. In the ongoing example, manager 126 shows all of the tiles of the group “stuck” to a selector of the gesture, such as stylus tip, fingertip, or mouse selector as that selector moves.

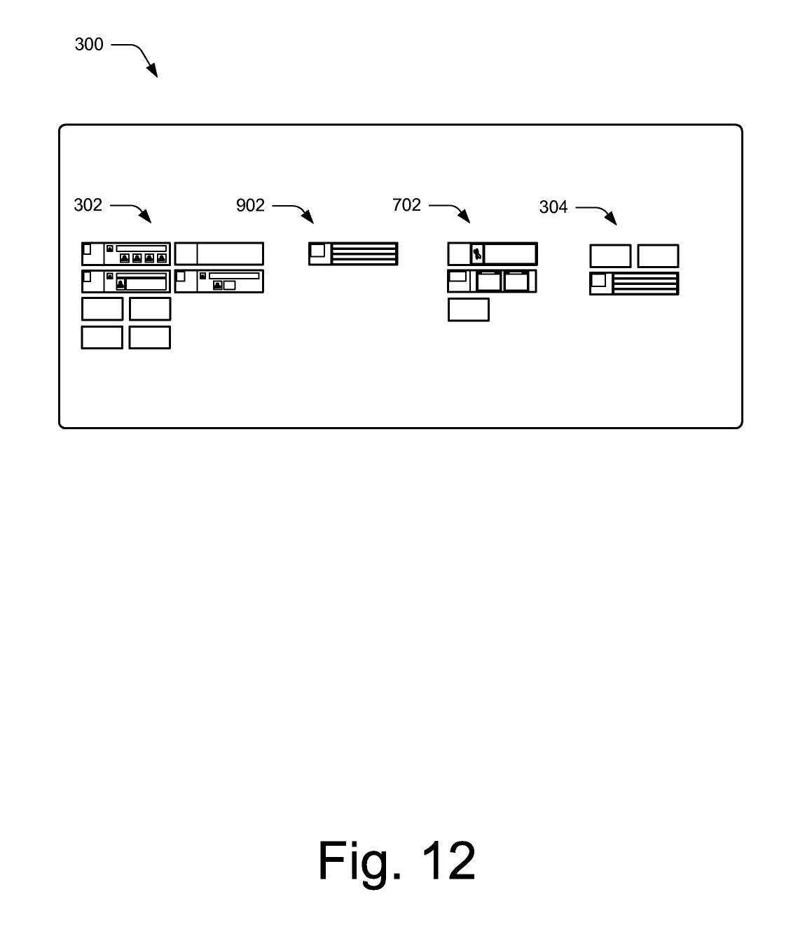

Block 1008 presents the selected group at the new location. Here manager 126 presents the selected group between groups 902 and 304, as shown in FIG. 12, and thus reordering groups from 302, 902, 304, 702, and 306 (306 not shown in FIGS. 9, 11, and 12) to 302, 902, 702, 304, and 306. Note that manager 126 also reorders the groups automatically, though this is not required.

The techniques permit other management of groups of tiles as well, such as automatically deleting groups responsive to removing a last tile of a group. Manager 126, in response to selection to move the only tile of group 902 of FIG. 9, for example, deletes group 902 and reorders the remaining groups.

Also, as noted above, the techniques permit selection to name any one or more of the groups. While not required, in some cases names, titles, and other identifiers aid users in finding a particular group, and thus a selectable tile. On selection of a name or other identifier, manager 126 places the name or identifier geographically proximate the appropriate group.

The preceding discussion describes methods in which the techniques may operate to group tiles. Aspects of these methods may be implemented in hardware (e.g., fixed logic circuitry), firmware, software, manual processing, or any combination thereof A software implementation represents program code that performs specified tasks when executed by a computer processor. The example methods can be performed through computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

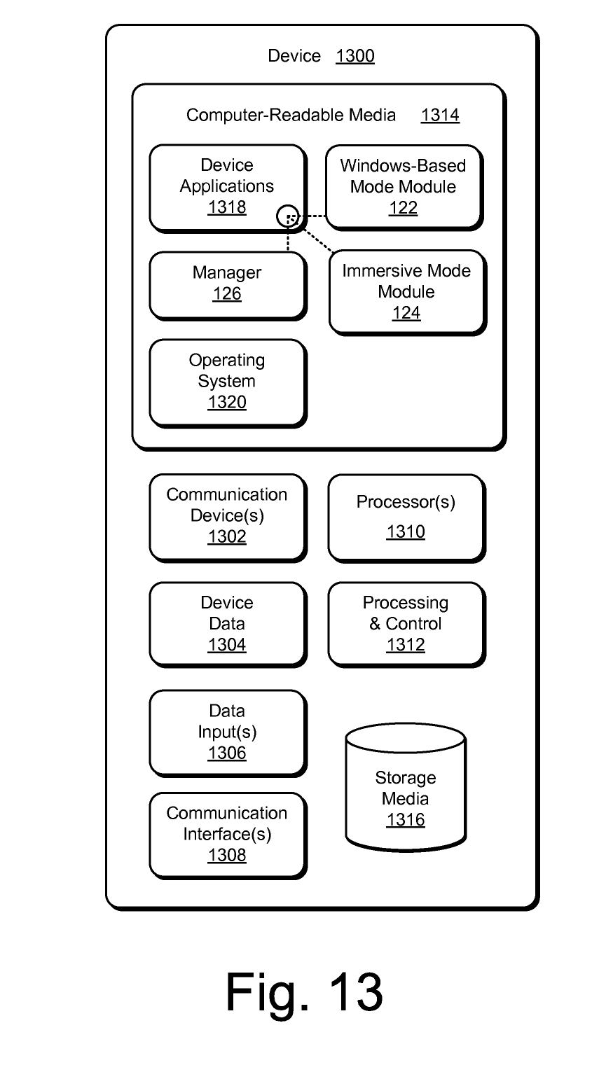

By way of example, these techniques may be embodied on one or more of the entities shown in system 100 of FIG. 1 and/or example device 1300 described below, which may be further divided, combined, and so on. Thus, system 100 and/or device 1300 illustrate some of many possible systems or apparatuses capable of employing the described techniques. The entities of system 100 and/or device 1300 generally represent software, firmware, hardware, whole devices or networks, or a combination thereof In the case of a software implementation, for instance, the entities (e.g., manager 126, mode modules 122 and 124) represent program code that performs specified tasks when executed on a processor (e.g., processor(s) 116). The program code can be stored in one or more computer-readable memory devices, such as computer-readable storage media 118 or computer-readable media 1314 of FIG. 13.

Example Device

FIG. 13 illustrates various components of an example device 1300 that can be implemented as any of the devices, or services and operations implemented by the devices, described with reference to the previous FIGS. 1-12. In some embodiments, device 1300 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 1300 may also be associated with a user (e.g., a person) and/or an entity that operates the device such that a device describes logical devices that include users, software, firmware, and/or a combination of devices.

Device 1300 includes communication devices 1302 that enable wired and/or wireless communication of device data 1304 (e.g., received data, data that is being received, data scheduled for broadcast, data packets of the data, etc.). The device data 1304 or other device content can include configuration settings of the device, media content stored on the device, and/or information associated with a user of the device. Media content stored on device 1300 can include any type of audio, video, and/or image data. Device 1300 includes one or more data inputs 1306 via which any type of data, media content, and/or inputs can be received, such as user-selectable inputs, messages, music, television media content, recorded video content, and any other type of audio, video, and/or image data received from any content and/or data source.

Device 1300 also includes communication interfaces 1308, which can be implemented as any one or more of a serial and/or parallel interface, a wireless interface, any type of network interface, a modem, and as any other type of communication interface. The communication interfaces 1308 provide a connection and/or communication links between device 1300 and a communication network by which other electronic, computing, and communication devices communicate data with device 1300.

Device 1300 includes one or more processors 1310 (e.g., any of microprocessors, controllers, and the like), which process various computer-executable instructions to control the operation of device 1300 and for grouping selectable tiles. Alternatively or in addition, device 1300 can be implemented with any one or combination of hardware, firmware, or fixed logic circuitry that is implemented in connection with processing and control circuits which are generally identified at 1312. Although not shown, device 1300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1300 also includes computer-readable storage media 1314, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1300 can also include a mass storage media device 1316.

Computer-readable storage media 1314 provides data storage mechanisms to store the device data 1304, as well as various device applications 1318 and any other types of information and/or data related to operational aspects of device 1300. For example, an operating system 1320 can be maintained as a computer application with the computer-readable storage media 1314 and executed on processors 1310. The device applications 1318 may include a device manager, such as any form of a control application, software application, signal-processing and control module, code that is native to a particular device, a hardware abstraction layer for a particular device, and so on.

The device applications 1318 also include any system components or modules to implement techniques for grouping selectable tiles. In this example, the device applications 1318 can include windows-based mode module 122, immersive mode module 124, and manager 126.

Conclusion

Although embodiments of techniques and apparatuses for grouping selectable tiles have been described in language specific to features and/or methods, the appended claims are not necessarily limited to the specific features or methods described. Rather, the specific features and methods are disclosed as example implementations for grouping selectable tiles.

What is claimed is:

1. A computer-implemented method comprising:
presenting multiple, selectable tiles within multiple groups, the groups separated by a visual element and presented simultaneously in a single user interface; and
responsive to selection of a selected tile, launching or presenting an application associated with the selected tile.

2. A computer-implemented method as described in claim 1, further comprising enabling selection to zoom into a selected group of the multiple groups, and, responsive to selection of the selected group, zooming into the selected group.

3. A computer-implemented method as described in claim 2, wherein zooming into the selected group presents the selectable tiles of the selected group at an increased size that do not fill a viewable region in which the selectable tiles of the selected group are presented, and further comprising simultaneously presenting, at the increased size, tiles of another, unselected group of the multiple groups.

4. A computer-implemented method as described in claim 1, further comprising receiving selection moving a selected group between two of the groups or in front of one of the groups, and responsive to the selection, moving the selected group between the two groups or in front of the one group.

5. A computer-implemented method as described in claim 4, wherein receiving selection moving the selected group drags the selected group from an original location in the single user interface and drops the selected group to blank space of a selected visual element, the blank space residing between the two groups or in front of the one group.

6. A computer-implemented method as described in claim 5, further comprising presenting the selectable tiles of the selected group during movement of the selected group.

7. A computer-implemented method as described in claim 1, further comprising receiving selection moving a second selected tile from one of the multiple groups to blank space of a selected visual element between two of the groups or in front of another one of the groups and, responsive to selection, automatically creating a new group in the blank space.

8. A computer-implemented method as described in claim 1, further comprising receiving selection moving a selected, last tile of one of the multiple groups, and responsive to selection, automatically deleting the one of the multiple groups.

9. A computer-implemented method as described in claim 1, further comprising enabling selection to name one of the groups and, responsive to receiving the name, presenting the name geographically proximate to the one of the groups in the single user interface.

10. A computer-implemented method as described in claim 1, further comprising:
receiving one or more selections moving two or more selected tiles of the selectable tiles to a region of the single user interface;
receiving a single selection of the two or more selected tiles moving, from the region, the two or more tiles to an existing group of the groups or a selected blank space; and
responsive to the single selection, adding the two or more selected tiles to the existing group or to a new group created at the selected blank space.

11. A computer-implemented method comprising:
presenting multiple tiles associated with multiple applications;
receiving a selection grouping a first group of tiles;
presenting, in a single user interface, the first group of tiles;
receiving a selection grouping a second group of tiles;
presenting, in the single user interface, the second group of tiles simultaneously with the first group of tiles and separated by a visual element;
enabling selection, through a selected tile of the first group of tiles or the second group of tiles, of an operation associated with the selected tile; and
responsive to selection of the selected tile, causing the operation to be performed.

12. A computer-implemented method as described in claim 11, wherein the operation is launching an application associated with the selected tile.

13. A computer-implemented method as described in claim 11, wherein receiving selection grouping the first group of tiles receives the first group of tiles, one-at-a-time, to a region of the single user interface.

14. A computer-implemented method as described in claim 11, further comprising enabling selection to move the first group or the second group with a single selection and, responsive to the single selection, altering an order of the first group and the second group in the single user interface.

15. A computer-implemented method as described in claim 14, wherein the single selection is a drag-and-drop of the first group or the second group from an original location in the order to a new location, the drop at a blank space at the new location.

16. A computer-implemented method as described in claim 11, wherein the visual element is a blank space that does not include chrome or a visual divider.

17. A computer-implemented method as described in claim 11, wherein the groups are not identified within the single user interface with a name or title.

18. A computer-implemented method comprising:
presenting, simultaneously in a single user interface, tiles associated with applications, the tiles arranged in groups separated by visual elements;
receiving selection to move a selected group of the groups from an original location to a new location in the single user interface;
responsive to selection, presenting movement of the selected group from the original location to the new location, the movement showing tiles within the selected group; and
presenting the selected group at the new location.

19. A computer-implemented method as described in claim 18, wherein the visual elements are blank space and receiving selection to move the selected group to the new location receives a drop of the selected group at a selected blank space within the single user interface and at the new location.

20. A computer-implemented method as described in claim 18, further comprising receiving selection of a selected one of the tiles and, responsive to the selection, launching an application associated with the selected one of the tiles.
